(19) United States
(12) Patent Application Publication
(10) Pub. No.: US 2023/0084571 A1
(43) Pub. Date: Mar. 16, 2023

(54) SYSTEM AND METHOD FOR GRINDING DISC TOOL

(71) Applicant: David Litkey, Green Bay, WI (US)

(72) Inventor: David Litkey, Green Bay, WI (US)

(21) Appl. No.: 17/891,143

(22) Filed: Aug. 19, 2022

Related U.S. Application Data
(63) Continuation of application No. 16/740,889, filed on Jan. 13, 2020, now abandoned.
(60) Provisional application No. 62/848,931, filed on May 16, 2019.

(51) Int. Cl. B24D 18/00; B24D 13/14; B24D 11/00; B32B 7/12; B24D 13/02; B24D 9/08; B24B 5/00

(52) U.S. Cl. CPC B24D 18/0045; B24D 13/14; B24D 11/001; B32B 7/12; B24D 13/02; B24D 9/08; B24B 5/00; B32B 2307/538; B32B 2250/03; B24D 2201/00; B32B 2475/00

(57) ABSTRACT

A system and method for a grinding disc, the grinding disc made out of three discs, capable of grinding in three positions such as the bottom, side, and top instead of only one position, the top disc and middle disc having an aperture such that a shaft having a washer and bar is connected to the discs by sliding the through the top disc whereby the washer is then received by the middle disc, the discs are then fastened together with the bar protruding from the discs whereby the bar may be connected to a tool such as drill, the grinding disc may then be used at multiple angles when connected to the tool

### RELATED APPLICATIONS

This application is a continuation that claims to U.S. non-provisional application Ser. No. 16/740,889 filed on Jan. 13, 2020 which claims priority to U.S. Provisional Application No. 62/848,931 filed on May 6, 2019, which is incorporated by reference in its entirety.

### FIELD OF DISCLOSURE

The overall field of this invention is directed to a surface finishing apparatus and, more particularly, to a rotatable driven surface grinding disc capable of being used in three positions for sanding and polishing a work surface as well as medical applications.

### BACKGROUND

There are many different types of rotary surface finishing discs on the market, each designed for a particular purpose or suitable for a different task or surface. Normally these finishing discs include abrasive particles, which are attached to a backing, such as with adhesive. Typically, the abrasive particles are located on the side of the disc that is intended to come into contact with a work surface when the disc is mounted to a surface finishing tool. These discs are inefficient because only a portion of the disc is in contact with the work surface leading this portion to wear out considerably faster than the other parts of the disc that are not in contact with the work surfaces. Also, when the surface in contact with the work surface has worn out, the entire disc needs to be replaced. Furthermore, situations may arise in which only having abrasive material on one side of the discs is not suitable. For example when using a finishing disc on a brake caliper bracket to remove buildup of corrosion or rust.

Customarily, brake caliper bracket corrosion occurs when the caliper is exposed to road de-icing salt or other environmental conditions. If the corrosion is not removed, the corrosion may cause the brake pads to bind even with the use of abasement clips as well as an increase in noises like squealing or growling, premature wear, and increased stopping distance. This type of corrosion is removed with a hand file or coarse wire brush but with multiple angles and different facing surfaces these types of tools require long periods of time combined with the need for more meticulous cleaning. Thus, exists a need for an improved grinding disc that is designed to provide efficient and even finishing of varied surfaces that are capable of grinding from three different positions when coming in contact with a work surface.

### SUMMARY

The disclosure presented herein relates to a grinding disc system, the system comprising, a top disc having an abrasive top and a second surface, a bottom disc having an abrasive bottom and a second surface, a middle disc having an abrasive edge, and a shaft, the shaft having a bar and a washer, the top disc having an aperture, the top disc configured to receive the bar through the aperture of the top disc, the middle disc having an aperture, the aperture of the middle disc configured to receive the washer wherein the washer rests within the aperture of the middle disc, the second surface of the bottom disc connected to the middle disc; the second surface of the top disc connected to the middle disc, the bottom disc connected to the middle disc by an adhesive, the top disc connected to the middle disc by an adhesive, the top disc formed from a grinding disc; the attaching button removed from the grinding disc, the bottom disc originally formed from a second grinding disc; the attaching button removed from the second grinding disc, the middle disc formed from a cut off wheel, further comprising a tool configured to be connected to the shaft, the bar having one or more threads configured to be received by the tool.

In another aspect, one or more embodiments are provided for a method for constructing a grinding disc system, the method comprising the steps of: forming an aperture into a top disc, the top disc having an abrasive side and a second side; forming an aperture into a middle disc, the middle disc having an abrasive edge around the perimeter of the middle disc; providing a bottom disc, the bottom disc having an abrasive side and a second side, placing a shaft through the aperture of the top disc, the shaft having a washer and a bar, adhering the washer to the second side of the top disc, adhering the middle disc to the second side of the top disc, the washer received inside the aperture of the middle disc, adhering the second side of the bottom disc to the middle disc, applying pressure for a predetermined time to set the adhesive, connecting the shaft to a tool, and finish grinding disc system.

### BRIEF DESCRIPTION OF DRAWINGS

The present invention will be described by way of exemplary embodiments, but not limitations, illustrated in the accompanying drawings in which like references denote similar elements, and in which:

FIG. 1A is an illustration showing a top view of the bottom disc of the grinding disc system.

FIG. 1B is an illustration showing a top view of the medium disc of the grinding disc system.

FIG. 1C is an illustration showing a top view of the top disc of the grinding disc system.

FIG. 1D is an illustration showing a top view of the shaft of the grinding disc system.

FIG. 2A is an illustration showing a top perspective view of the assembled grinding disc system.

FIG. 2B is an illustration showing a bottom perspective view of the assembled grinding disc system.

FIG. 2C is an illustration showing a perspective side view of the assembled grinding disc system.

FIG. 2D is an illustration showing a top view of the assembled grinding disc system.

FIG. 2E is an illustration showing another perspective side view of the assembled grinding disc system.

FIG. 2F is an illustration showing another perspective side view of the assembled grinding disc system.

FIG. 3 is an illustration showing a front perspective view of the first jig.

FIG. 4 is an illustration showing a top perspective view of the first jig.

FIG. 5 is an illustration showing another top perspective view of the first jig.

FIG. 6 is an illustration showing a broken top perspective view of the first jig.

FIG. 7 is an illustration showing a bottom perspective view of the first jig.

FIG. 8 is an illustration showing a perspective view of the second jig.

FIG. 9A-9B are illustrations showing the components of the second jig.

FIG. 10 is an illustration showing another perspective view of the second jig.

FIG. 11 is an illustration showing a perspective view of the third jig.

FIG. 12 is an illustration showing a perspective view of the assembled grinding disc system connected to a drill.

FIG. 13 is an illustration showing a perspective view of different embodiments of the shaft.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items” may indicate the presence of only one item, or may indicate more items. Thus, the term “set” may be equivalent to “one or more” as used herein.

The present disclosure recognizes the unsolved need for a grinding disc made out of three discs, capable of grinding in three positions such as the bottom, side, and top instead of only one position. The grinding disc is suitable for speeding up tedious processes such as brake caliper bracket cleaning as well as other processes in the areas of welding, automobiles, metal fabrication, woodworking, plastics, and other hobbies. The grinding disc may also be applicable in the field of dentistry to perform a variety of procedures, including removing decay, polishing fillings, and altering prostheses from multiple angles and differently sized teeth.

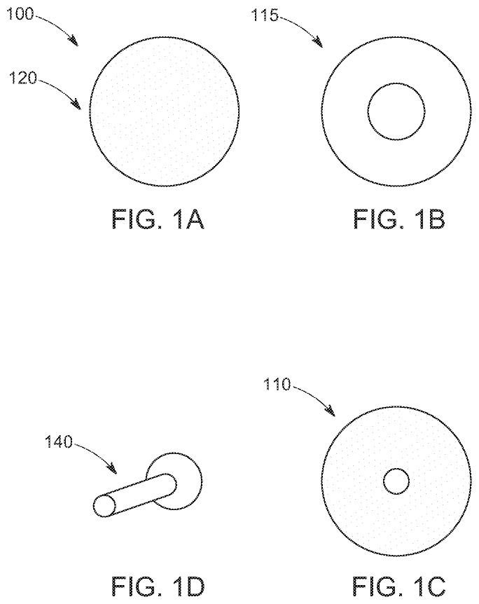

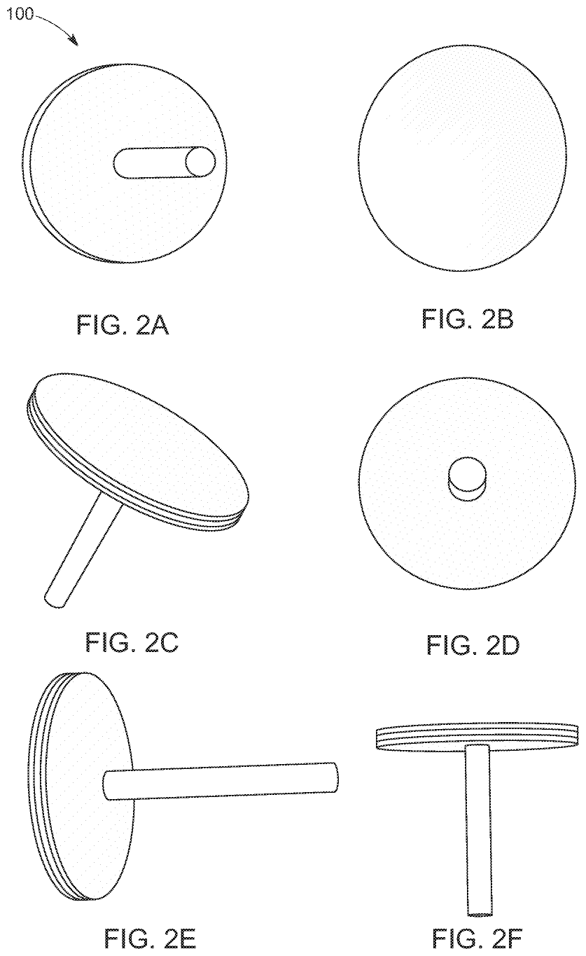

With reference now to FIG. 2, one exemplary embodiment of grinding disc system 100 of 0.185 inch thickness, according to the present invention is generally designated, for use with a rotary surface tool. Grinding disc system 100 includes a consistent diameter bottom disc of 0.060 inch thickness having a single abrasive surface on the continuous uninterrupted bottom such as bottom disc 120, as illustrated in FIG. 1A, a middle disc of 0.065 inch thickness having an abrasive edge around the perimeter such as middle disc 115 with a larger aperture than the top and bottom disc, as illustrated in FIG. 1B and a non-abrasive top and bottom, a consistent diameter top disc of 0.060 inch thickness having a single abrasive surface on a continuous uninterrupted top such as top disc 110, as illustrated in FIG. 1C, and an elongated shaft such as shaft 140, as illustrated in FIG. 1D, allowing for maximum usage of the abrasive top of top disc 110 by providing ample space when connected to a tool. Abrasive particles are positioned on each disc to contact a work surface, scraping off the top coating or layer of the work surface, such that the rotation of grinding disc system 100 causes the abrasive particles on discs 110, 115, and 120 to sand or abrasively wear away the work surface.

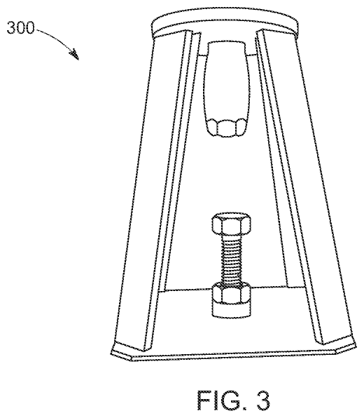

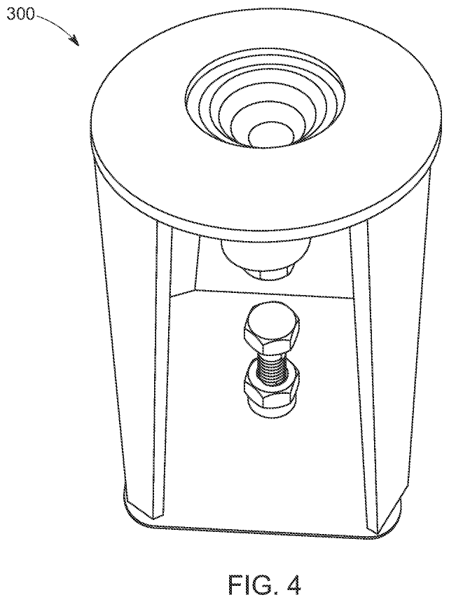

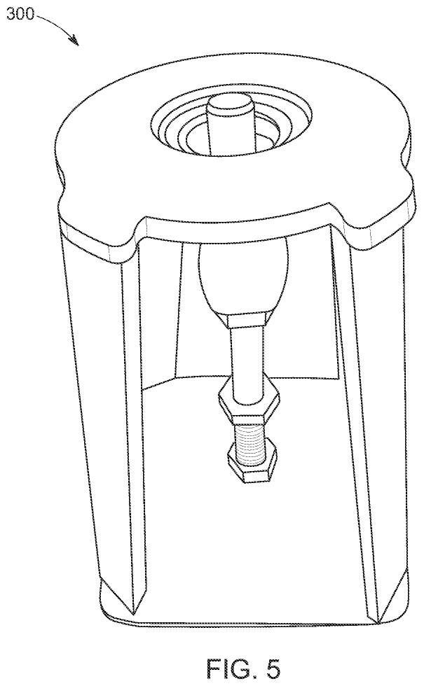

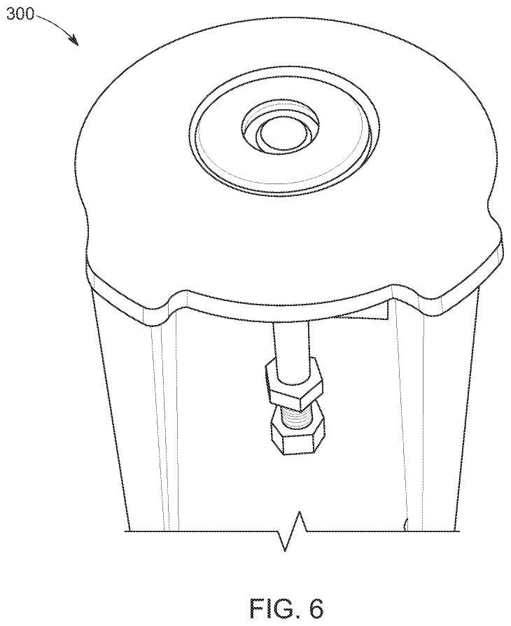

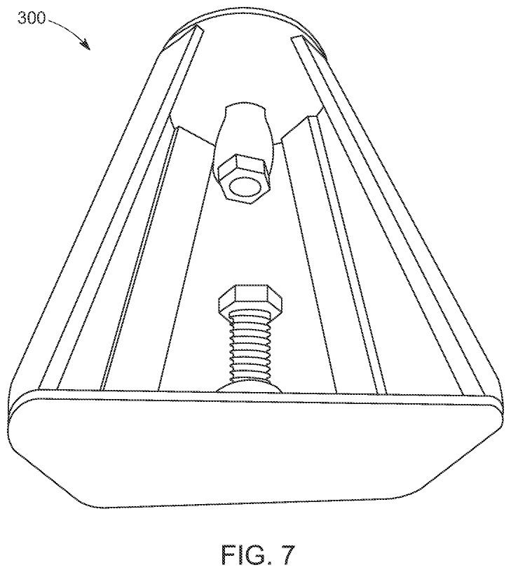

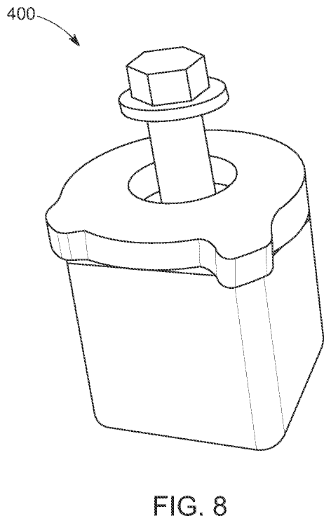

Shaft 140 may include a bar such as bar 142 and flat washer or rounded element such as washer 144. In one or more non-limiting embodiments, bar 142 may be ¼″×2¼″ with a ¾″ outside diameter. Bar 142 may have a first and second end whereby the first end may be welded to a washer 144 having an outside diameter of ¾″ and inside diameter of ¼″ using a custom first jig such as jig 300 as illustrated in FIG. 3-7 or other apparatus known by those of ordinary skill in the art. Jig 300 may provide repeatability, accuracy, and interchangeability in the manufacturing of grinding disc system 100, whereby jig 300 holds and guides the tools during the manufacturing process of grinding disc system 100. Bar 142 and washer 144 may be grinded to ensure smooth surfaces. Small frictional grooves on the outside edge of washer 144 may also be cut away. In one or more non-limiting embodiments, bar 142 and washer 144 may be integral to one another or otherwise already welded together or fastened.

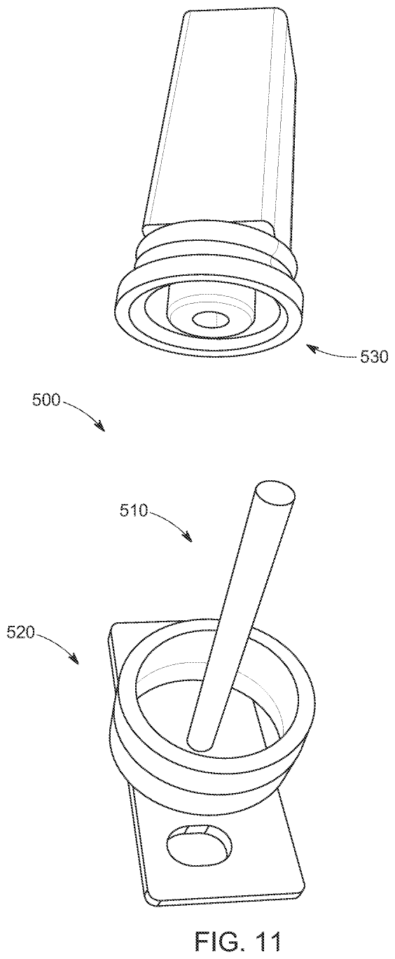

In one or more non-limiting embodiments, a third jig such as jig 500, as illustrated in FIG. 11 may be used whereby middle disc 115 is a 3″ cut off wheel having an aperture therethrough. Middle disc 115 is placed over a bar such as bar 510 of base 520, a cutter such as cutter 530 having a cavity may be positioned over bar 510 whereby bar 510 is received into the cavity of cutter 530. When cutter 530 has been positioned over base 520, a hammer may be used to reduce the 3″ cut off wheel into a 2″ cut off wheel.

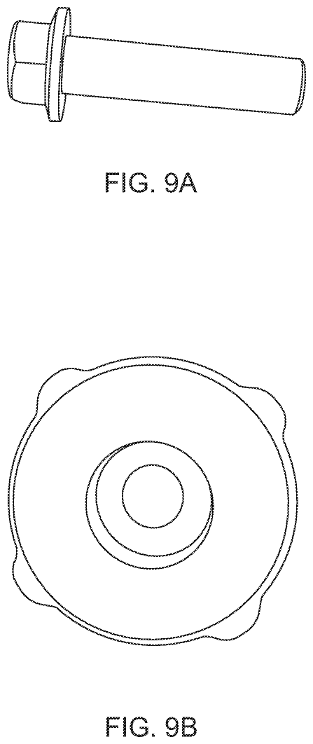

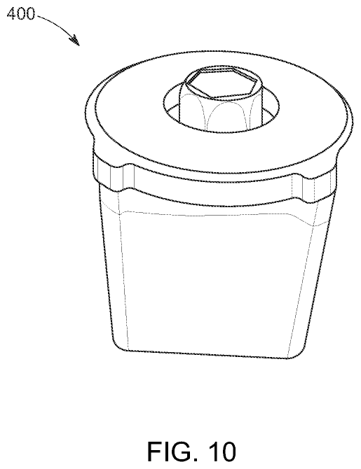

Middle disc 115 formed from a 3″ cut off wheel originally having a ⅜″ aperture, whereby a second custom jig such as jig 400, as illustrated in FIG. 9-10 or other apparatus is used to punch or otherwise form a ¾″ aperture from the original ⅜″ aperture. In one or more non-limiting embodiments, middle disc 115 may already have the aperture integrally formed.

Top disc 110 and bottom disc 120 may originally be formed from a grinding disc such as but not limited to a grinding 2″ 80 Grit whereby the attaching buttons may be removed from the grinding disc. Top disc 110 and bottom disc 120 may have different grit depending on the circumstances needed. A ¼″ aperture then may be drilled or otherwise created into a preferably centrally located location of top disc 110. In one or more non-limiting embodiments, top disc 110 and bottom disc 120 may not have attaching buttons or otherwise have them already removed. Top disc 110 may be formed with an aperture already present or otherwise formed.

Jig 300 may be used to assemble grinding disc system 100 by positioning top disc 110 abrasive side down on top of jig 300. Adhesive then may be applied to the non-abrasive side of top disc 110. The adhesive is preferably chosen to work well under the high pressure and temperature conditions present during a normal grinding or surface finishing operation. In one or more non-limiting embodiments, the adhesive may be an epoxy type of adhesive.

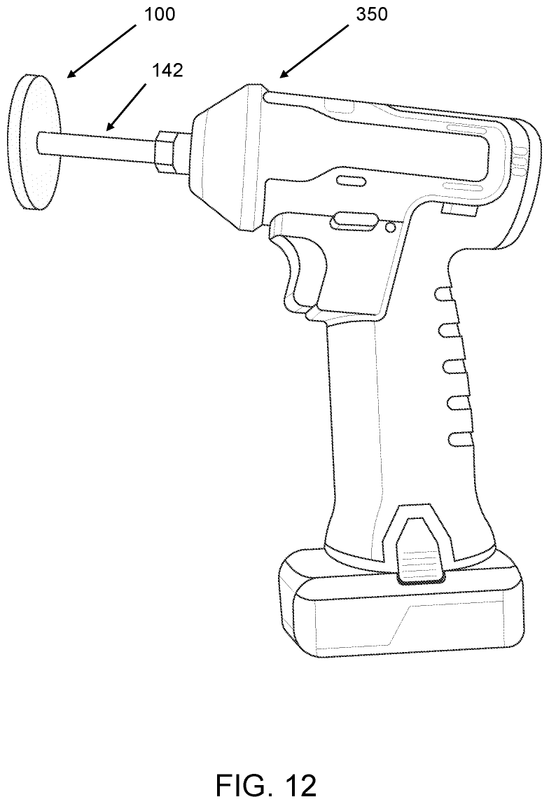

The adhesive may then be applied to washer 144 whereby bar 142 is placed through the aperture of top disc 110 whereby washer 144 adheres to the non-abrasive side of top disc 110 and the non-abrasive side of bottom disc 120. Adhesive may then be applied to middle disc 115 whereby middle disc 115 is then placed on top of top disc 110 such that washer 144 may be received inside the inside aperture of middle disc 115. Adhesive then may be applied to non-abrasive side of bottom disc 120 whereby bottom disc 120 is then placed on top of middle disc 115 abrasive side up. Pressure then may be applied for a predetermined time to set the adhesive and finish assembly of grinding disc system 100. Grinding disc system may then be connected to any type of tool or device known by those of ordinary skill in the art such as a drill 350 whereby bar 142 may be connected to or otherwise received by drill, as illustrated in FIG. 12. In one or more alternating embodiments grinding disc system 100 may be made of a material such that it can bend for more precision grinding and finishing. In other embodiments top disc and bottom disc may have a lower edge such that they may snap onto middle disc which has a recess to receive the lower edges of the top and bottom disc such that the discs may be removed from one another with enough force such that different suitable discs may be used.

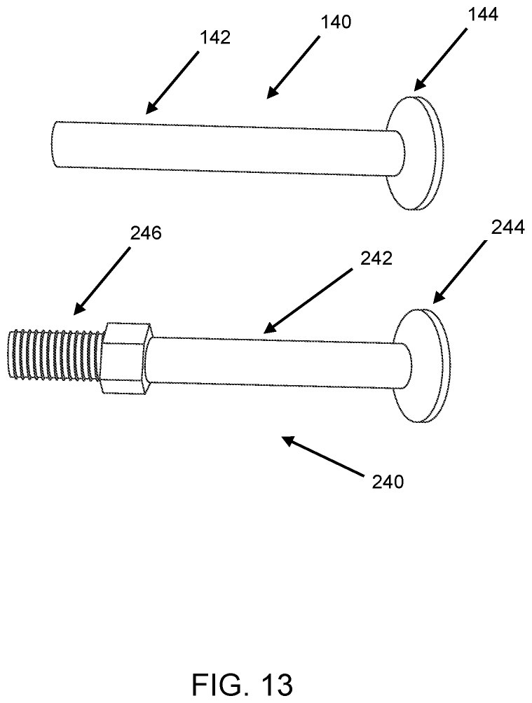

In one or more non-limiting embodiments as illustrated in FIG. 13, a shaft such as shaft 240 may have threaded portion 246 on the exterior of the bar 242 near the end opposite of a washer such as washer 244. The threaded configuration allows shaft 240 to engage and mechanically lock with a tool. Correspondingly, drill 350 may have a threaded portion or be textured with a gnarled surface of one or more silicon threads with a metal core so as to mechanically lock shaft 240 to tool 350.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A method for constructing a grinding disc system, the method comprising steps of:
forming an aperture into a top disc, the top disc having an abrasive side and a second side;
forming an aperture into a middle disc, the middle disc having an abrasive edge around a perimeter of the middle disc; and
forming a bottom disc, the bottom disc having an abrasive side and a second side.

2. The method of claim 1, the method further comprising the steps of:
placing a shaft through the aperture of the top disc, the shaft having a washer and a bar.

3. The method of claim 2, the method further comprising the steps of:
adhering the washer to the second side of the top disc.

4. The method of claim 3, the method further comprising the steps of:
adhering the middle disc to the second side of the top disc, the washer received inside the aperture of the middle disc.

5. The method of claim 4, the method further comprising the steps of:
adhering the second side of the bottom disc to the middle disc.

6. The method of claim 5, the method further comprising the steps of:
applying pressure for a predetermined time to set adhesive.

7. The method of claim 6, the method further comprising the steps of:
connecting the shaft to a tool.

8. The method of claim 7, the method further comprising the steps of: welding a first end of the bar to the washer using a first jig.

9. The method of claim 8, the method further comprising the steps of: using a second jig where the middle disc is placed over a jig bar of a base wherein a cutter having a cavity is positioned over the jig bar wherein the bar is received into the cavity of the cutter, wherein a hammer is used to reduce the middle disc.

10. A method for creating a grinding disc system, the method comprising:
forming a grinding disc having a top disc having a single abrasive surface that is on a top, the top disc having a continuous sized uninterrupted circular aperture with a consistent diameter therethrough, a bottom disc having a single abrasive surface that is on a bottom that is a continuous uninterrupted surface, and a middle disc having an abrasive edge, the middle disc having a continuous sized uninterrupted aperture therethrough wherein an entirety of the aperture in the middle disc is of larger size than the aperture in the top disc.

11. The method of claim 10, the method further comprising:
positioning a shaft in the grinding disc, the shaft having a rounded element positioned into the aperture of the middle disc and adhered the top disc and the bottom disc, the shaft having a bar connected to the rounded element and positioned through and attached to the top disc, wherein the bar and the rounded element are integral to one another.

12. The method of claim 11, the method further comprising: connecting the top disc, the middle disc, and the bottom disc by adhesive and pressed together.

13. The method of claim 12, wherein the aperture of the middle disc is ¾ inches in diameter and the aperture of the top disc is ¼ inches in diameter.

14. The method of claim 13, wherein the rounded element having an outside diameter of ¾ inches and inside diameter of ¼ inches.

15. The method of claim 14 the method further comprising: forming the middle disc from a cut off wheel.

16. The method of claim 14 the method further comprising: machining the shaft to be 4″ in diameter and the rounded element having a ¾″ outer diameter.

17. The method of claim 11, the method further comprising: connecting a spinning tool configured to the shaft.

18. The method of claim 11, the method further comprising: welding a first end of the bar to the rounded element using a jig.

19. The method of claim 11, the method further comprising: using a jig where the middle disc is placed over a jig bar of a base wherein a cutter having a cavity is positioned over the jig bar wherein the jig bar is received into the cavity of the cutter, wherein a hammer is used to reduce the middle disc.

20. The method of claim 11, the method further comprising: using a jig for positioning the top disc upside down on top of the jig wherein adhesive then is applied to a non-abrasive side of the top disc.
